(19) United States
(12) Patent Application Publication
(10) Pub. No.: US 2013/0191304 A1
(43) Pub. Date: Jul. 25, 2013

(54) Tools and Methods for Creating Dynamic Feedback Forms

(71) Applicants: Dale Ellen Gaucas, Penfield, NY (US); Michael David Shepherd, Ontario, NY (US); Kirk J. Ocke, Ontario, NY (US)

(72) Inventors: Dale Ellen Gaucas, Penfield, NY (US); Michael David Shepherd, Ontario, NY (US); Kirk J. Ocke, Ontario, NY (US)

(73) Assignee: XEROX CORPORATION, Norwalk, CT (US)

(21) Appl. No.: 13/358,447

(22) Filed: Jan. 25, 2012

(51) Int. Cl. G06Q 30/02

(52) U.S. Cl. 705/347

(57) ABSTRACT

Apparatus are provided that includes a consumer access device configured to provide a product consumer with access to an online store and to allow the product consumer to enter data into a feedback form relating to a product purchased from a provider. A provider device is configured to communicate with the consumer access device information regarding the product such that the product consumer can input feedback information in the feedback form. A feedback engine is configured to process data regarding the product such that the feedback form is updated by the feedback engine. The feedback engine can be configured to communicate with one or more databases of product information to obtain updated data regarding the product such that the feedback form can be updated, and the feedback engine can be configured to adjust the level of detail in the feedback form depending on the knowledge of the product consumer.

### FIELD OF THE DISCLOSURE

Aspects of the present disclosure relate to tools for communicating among various parties. Other aspects relate to tools for coordinating data collection and communication among different parties, e.g., in order to create and manage consumer feedback forms and consumer feedback data.

### BACKGROUND

Consumer feedback is an increasingly important source of information for companies, as the information is used in market research and the analysis of consumer response to products. This information can be used, for example, to facilitate product design changes or in the introduction of new products to the marketplace. Current methods of collecting consumer feedback, in form of checkboxes regarding the product or text boxes that allow the consumer to enter text regarding the product, do not always capture information about product features or provide the level of detail about product features that are important to the consumer, and may not be flexible enough to remain current as the features and details of a product are updated by the company.

### SUMMARY

In accordance with one aspect of the present disclosure, apparatus are provided that include a consumer access device configured to provide a product consumer with online access to an online store. The consumer access device can have a display configured to display a feedback form for a given product, and the consumer access device can include input features to allow the product consumer to enter data into the feedback form relating to the product purchased by the product consumer from a provider. A provider device is configured to communicate with the consumer access device information regarding the product such that the product consumer can input feedback information regarding the product in the feedback form. A feedback engine is configured to process data regarding the product such that the feedback form is updated by the feedback engine. The feedback engine can be configured to communicate with one or more databases of product information to obtain updated data regarding the product such that the feedback form can be updated, and the feedback engine can be configured to adjust the level of detail in the feedback form depending on the knowledge of the product consumer such that the feedback form varies depending on the product consumer.

### BRIEF DESCRIPTION OF THE DRAWINGS

Embodiments of the disclosure are further described in the detailed description which follows, by reference to the noted drawings, in which like reference numerals represents similar parts throughout the several views of the drawings, and wherein:

FIG. 1 is a block diagram of one embodiment of a communication system for creating and updating dynamic feedback forms;

FIG. 2 is a functional schematic diagram of a screen or a window of a consumer access device displaying product information in one embodiment of the disclosure;

FIG. 3 is a functional schematic diagram of a screen or a window of a consumer access communications device displaying a feedback form in one embodiment of the disclosure;

FIG. 4 is a flowchart of one embodiment of a process for creating and updating a dynamic feedback form; and

FIG. 5 is a flowchart of another embodiment of a process for creating and updating a dynamic feedback form.

### DETAILED DESCRIPTION

Aspects of the disclosure are directed to a communication system that includes a feedback engine for creating, managing, and/or updating feedback forms that are presented to product consumers that have purchased a given product for collection of product consumer feedback regarding the product. The feedback form is dynamic such that the feedback form can be updated as information about the product is updated, and the feedback form can vary depending on the level of expertise of the product consumer that is executing the feedback form.

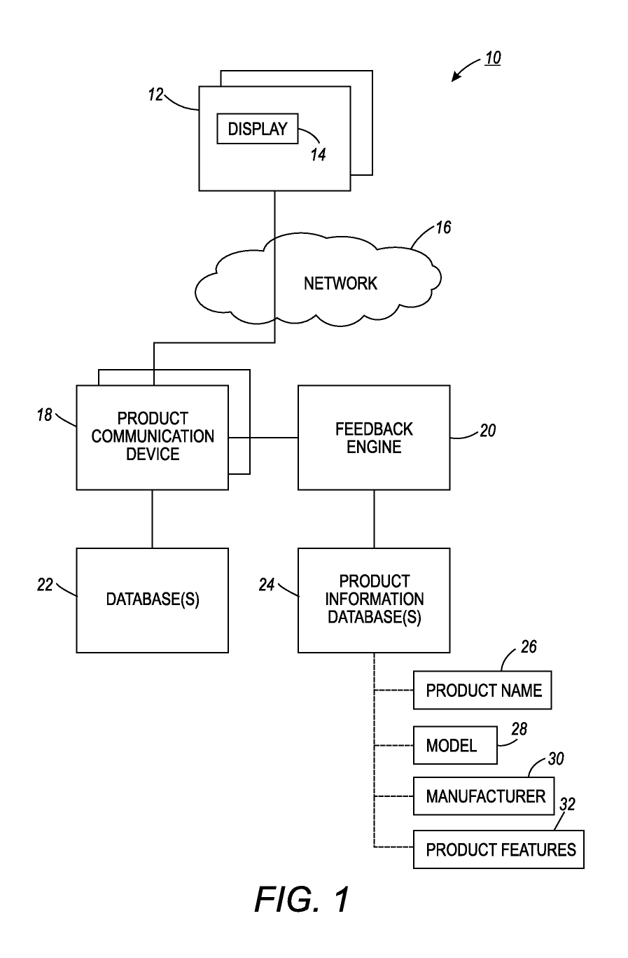

Referring now to the drawings in greater detail, FIG. 1 shows a block diagram of a communication system 10 that includes a data communication network 16 that is in communication with one or more consumer access devices 12 configured to transmit and/or receive a variety of types of data and/or messages, including one or more product information pages and feedback forms, to and from other devices via the data communication network 16. The consumer access device 12 can have online access to the various components of the system via an Internet browser, such as an Internet access application. The Internet access application can be configured to interface, for example, with an online store, such as an Internet storefront, to allow the product consumer to purchase a product and access a feedback form regarding the product using the consumer access device 12. The Internet access application can be an application for a variety of devices, including a smartphone.

One or more product communication devices 18 are also provided that are configured to transmit and/or receive various types of data and messages, including offers for products on product information pages and/or feedback forms to the consumer access devices 12. The consumer access devices 12 and the product communication devices 18 can include an interface, such as a network interface or other type of interface, to allow the devices 12, 18 to communicate through the network 16 with each other and other components and/or devices through the communications system 10. The consumer access device 12 can also include an interface for interfacing with a remote server for displaying a feedback form on a display 14 of the consumer access device 12.

The communications system 10 also includes various components for creating, managing, and/or updating feedback forms associated with a product that can be purchased by a product consumer using the consumer access device 12. In one embodiment, the communication system 10 includes a feedback engine 20, and one or more data repositories, including a one or more product information databases 24 that can be accessed via an interface with a remote server, and various other databases 22 for storing data. The engine can be in the form of configuration tools to allow the communications system 10 to aggregate and configure sets of assets or data, including data regarding the product information in order to set up and update one or more feedback forms.

As explained above, the engine is provided to manage the interactions within the communications system 10. In one embodiment, the feedback engine 20 is provided and it is configured to manage the setup and/or management and/or update of feedback forms communicated to the product consumers. In the process of setting up, managing, and/or updating one or more feedback forms, the feedback engine 20 can search for and collect data regarding the product for purchasing by the product consumer, and that data is stored in one or more databases 22 located in the communications system 10.

As explained above, various databases can be used to store information regarding the products and feedback forms, including the one or more product information databases 24. The product information databases 24 can contain a variety of information about a plurality of products and/or services that can be included when presented to a product consumer for purchase, for example, on a product web page on an online retail site. Various sources of information can be used for retrieving information about the product or service such that the feedback form associated with the product can be updated. For example, there are various product ontologies and product knowledge bases that contain information about a plurality of products and services that can be accessed by the feedback engine 20 to update the feedback form when the product information changes. These repositories of information can be used to access information about the product that can be included in the feedback form. For example, encyclopedic knowledge-bases are used to capture a variety of knowledge using Linked Open Data and ontological representations. Some of these knowledge-bases use languages, such as OWL, to provide a structured framework to convey meaning to the Linked Data. Examples of ontologies include, but are not limited to, DBpedia, GoodRelations, eClassOWL, Consumer Electronics Ontology, and FOAF. An example of a knowledge base for product data is the Linked Open Commerce Data Space which uses the Consumer Electronics Ontology.

When the feedback engine 20 queries one or more of the product information databases, a large amount of information may be returned about the product. The information may be hierarchical and may have varying degrees of detail about the product. This can be accomplished in a variety of ways. For example, properties, or product features, associated with a product type or class can be obtained by querying the Consumer Electronics Ontology in OWL format. In one embodiment, this can be accomplished automatically. The query can be expressed programmatically using an interface such as the OWL API. The properties, or product features, obtained by the query can then be used to determine those that are applicable for a particular product instance, for example, a particular product model, by using an RDF query language such as SPARQL to query a database such as the Linked Open Commerce data space. In one embodiment, this query can be accomplished automatically. Such queries can return a set of property-value pairs for the product model where a non-empty property value indicates that the property corresponds to an actual product feature for that model. Such a product feature can then be incorporated, for example, automatically, into a feedback form. Because of the hierarchical nature of the product information databases and the ability to navigate them using their supported interfaces, the degree of detail that is incorporated in a feedback form can be controlled and adjusted according to a product consumer's level of expertise.

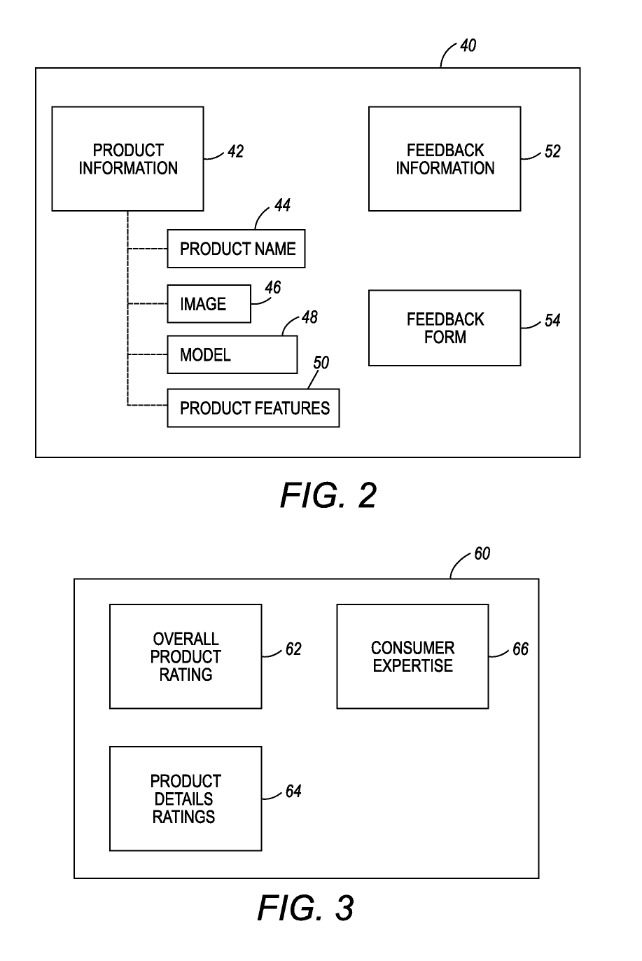

In order for a product consumer to have access to a feedback form for the product consumer to submit feedback about the product, in one embodiment a consumer must purchase the product. The feedback form can then be presented to the product consumer automatically, or the product consumer can choose to view the feedback form, for example, by selecting a feedback icon on the display 14 of the consumer access device 12. There are various ways for a product consumer to purchase a product, but in illustrated embodiment in FIG. 2, a product consumer can be presented with a product page 40 from an online store, for example, an Internet storefront, to allow the product consumer to view information about the product and purchase the product. The product page 40 can present a variety of product information 42 to the product consumer. For example, the product information 42 can include the product name 44, an image 46 of the product, a model 48, and various other product details 50 depending on the type of product and the features that the product includes. It will be appreciated that any information about the product can be presented to the product consumer on the product page 40.

The product page 40 can also include feedback information 52. The feedback information 52 can include an overall rating of the product based on all or a subset of previous ratings of the product by product consumers, comments from previous purchasers of the product, and/or ratings of various product features. The product page 40 can also include a feedback form 54, which can be in the form of a tool that allows the product consumer to access the feedback form and enter feedback information regarding the product after the product consumer has purchased the product.

The feedback form 54 is dynamic, such that the information in the feedback form 54 can be updated using the information in the product information databases 24 as that information changes. This allows the feedback form 54 to always contain current and updated information about the product when a product consumer accesses the feedback form 54. The feedback form 54 can be updated in a variety of ways. In one embodiment, the feedback engine 20 is configured to update the feedback form 54 automatically upon the receipt of updated product data from the one or more databases of product information. For example, the feedback engine 20 can be configured to query the product information databases 24 at a predetermined interval. Whenever updated product information is found during these routine queries, the feedback engine 20 will update the feedback form 54 to include the updated product information. In another embodiment, the feedback engine 20 can be configured to update the feedback form 54 upon execution of a feedback form by the product consumer. For example, when a product consumer attempts to access and execute a feedback form, the feedback engine 20 can query the product information databases 24 for updated product information. If updated product information is found during this query, the feedback engine 20 will update the feedback form.

The feedback form 54 can include a variety of types of information and can include various levels of detail regarding the product and product features depending on the product consumer that will be executing the form. Thus, different product consumers may view different versions of the feedback form for the same product based on the level of expertise of the product consumer regarding the product. For example, if the product consumer uses the product for professional purposes, the feedback form will include more detailed features of the product for the product consumer to review. There are various ways for the product consumer to communicate their level of expertise to the feedback engine 20 to allow the feedback engine 20 to vary the product information on the feedback form. For example, the feedback form can include various inputs to allow the product consumer to indicate their level of expertise, as will be discussed in more detail below.

In one embodiment illustrated in FIG. 3, a feedback form 60 can include an overall product rating tool 62 that allows the product consumer to rate the product as a whole. The overall product rating tool 62 may be in the form of a graphical tool to allow the product consumer to enter information therein. When graphical tools are provided, the graphical tools may be graphical input/output tools that communicate to the product consumer the type of information to be input, and then accept that input from the product consumer. The overall product rating tool 62 may include an input field for text to allow the product consumer to enter text regarding their overall rating of the product, or may include selection mechanisms to allow the product consumer to rate the product. For example, the overall ratings tool 62 may include a plurality of checkboxes or a star rating system to allow the product consumer to rate the product using a rating system. The options for rating the product may be presented to the product consumer using text, icons, pictures, or other graphical indicators communicating the choices to the product consumers.

The feedback form 60 may also include other tools to allow the product consumers to enter additional information about the product. The product details ratings tool 64 is configured to allow the product consumer to enter feedback about various other features of the product. Similar to the overall product ratings tool 62, the product details ratings tool 64 can be a graphical tool that can include one or more input fields for text to allow the product consumer to enter text regarding feedback of various features of the product, or may include selection mechanisms to allow the product consumer to rate various features of the product. In one embodiment, the level of detail of product features presented to the user for feedback using the product details ratings tool 64 depends on the level of expertise of the product consumer, as discussed above. The feedback form 60 can include a consumer expertise tool 66 that is configured to allow the product consumer to communicate their level of expertise to the feedback engine through the feedback form. The consumer expertise tool 66 can also be a graphical tool that can include one or more input fields for text to allow the product consumer to enter text regarding their level of expertise, or may include selection mechanisms to allow the product consumer to select a level of expertise from predetermined knowledge levels, which can range from a novice user to a professional user. The feedback engine uses this information to adjust the level of detail regarding product features presented to the product consumer in the product details ratings tool 64.

The feedback form can change in a variety of ways based on the level of expertise of the product consumer executing the feedback form. In one embodiment, the amount of information a product consumer can enter regarding a particular product feature can change depending on the level of expertise of the product consumer. For example, if the product consumer has a high level of expertise, the product consumer may be able to enter text to comment on a product feature, while the product consumer with a low level of expertise may only be able to utilize checkboxes or a star rating system to rate a product feature. In another embodiment, the ability to rate certain product features on the feedback form will only be available to product consumer that have higher levels of expertise. It will be appreciate that any of these techniques for altering the feedback form based on the level of expertise of the product consumer can be used alone or in any combination.

The level of expertise entered in the consumer expertise tool 66 can also be used in other ways in the communication system 10. For example, the feedback from each product consumer entered into a feedback form and processed by the feedback engine can be tagged with information about the level of expertise of the product consumer. In one embodiment, when the feedback information 52, shown in FIG. 2, is viewed for a particular product, the feedback information can indicate the level of expertise of the product reviewer such that the product consumer viewing the information can weigh the feedback based on the level of expertise of the review. In another embodiment, once the feedback engine has received information about the level of expertise of a product consumer, the product consumer may only be presented with previous feedback information about the product from consumers with the same or similar level of expertise.

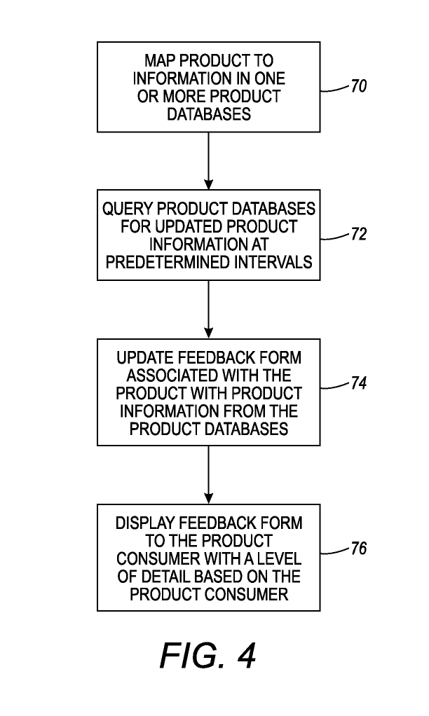

FIG. 4 shows a flowchart of one embodiment of processes that allow a feedback form to be created and/or updated and communicated to one or more product consumers by the communication system 10. The illustrated processes are carried out, in the illustrated embodiment, by the communications system 10 shown in FIG. 1. In act 70, a mapping is done to identify product information databases that contain information about a particular product. In act 72, the product information databases are queried at regular, predetermined intervals to locate updated product information. In act 74, the feedback form is updated with the updated product information found from the query performed in act 72. The feedback form with the updated product information is displayed to the product consumer in act 76.

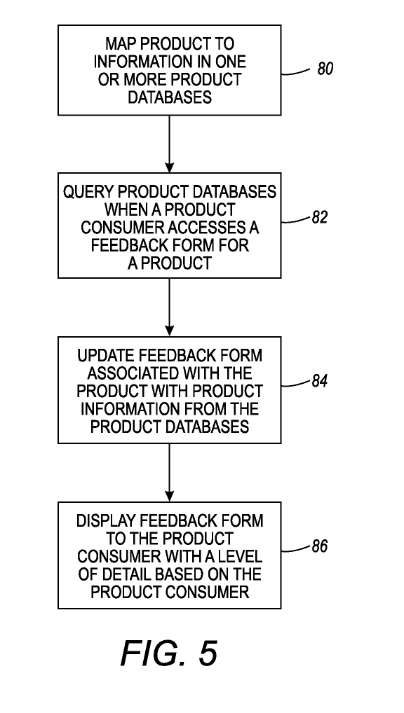

FIG. 5 shows a flowchart of another embodiment of processes that allow a feedback form to be created and/or updated and communicated to one or more product consumers by the communication system 10. In act 80, a mapping is done to identify product information databases that contain information about a particular product. In act 72, the product information databases are queried when a product consumer accesses a feedback form for the product. In act 84, the feedback form is updated with the updated product information found from the query performed in act 82. The feedback form with the updated product information is displayed to the product consumer in act 86.

Any given engine or tool referred to herein or any functionality referred to herein may be implemented with one or more processing circuits. For example, a processing circuit, or a processing mechanism, may include both (at least a portion of) computer-readable media carrying functional encoded data and components of an active computer. The active computer is ready to execute (or is already executing) the functional encoded data, and thereby causes certain acts to occur. A processing circuit may also include: a machine or part of a machine that is specially configured to carry out a process, e.g., any process described herein; or a special purpose computer or a part of a special purpose computer. A processing circuit may also be in the form of a general purpose computer running a compiled, interpretable, or compilable program (or part of such a program) that is combined with hardware carrying out a process or a set of processes. A processing circuit may further be implemented in the form of an application specific integrated circuit (ASIC), part of an ASIC, or a group of ASICs. A processing circuit may further include an electronic circuit or part of an electronic circuit. Neither a processing circuit nor a process mechanism exists in the form of code per se, software per se, instructions per se, mental thoughts alone, or processes that are carried out manually by a person without any involvement of a machine.

The claims as originally presented, and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. Apparatus, comprising:
a consumer access device configured to provide a product consumer with online access to an online store, the consumer access device having a display configured to display a feedback form for a given product, the consumer access device including input features to allow the product consumer to enter data into the feedback form relating to the product purchased by the product consumer from a provider;
a provider device configured to communicate with the consumer access device information regarding the product such that the product consumer can input feedback information regarding the product in the feedback form;
a feedback engine configured to process data regarding the product such that the feedback form is updated by the feedback engine, the feedback engine configured to communicate with one or more databases of product information to obtain updated data regarding the product such that the feedback form can be updated, wherein the feedback engine is configured to adjust the level of detail in the feedback form depending on the knowledge of the product consumer such that the feedback form varies depending on the product consumer.

2. The apparatus of claim 1, wherein the product consumer has online access via an Internet browser.

3. The apparatus of claim 2, wherein the Internet browser is in the form of an Internet access application.

4. The apparatus of claim 3, wherein the Internet access application is configured to interface with the online store.

5. The apparatus of claim 3, wherein the Internet access application is an application for a smartphone.

6. The apparatus of claim 1, wherein the online store is an Internet storefront.

7. The apparatus of claim 1, wherein the feedback form is presented on the display of the consumer access device as a result of the product consumer having purchased the product.

8. The apparatus of claim 7, wherein the feedback form is presented automatically.

9. The apparatus of claim 1, wherein the feedback form is presented on the display of the consumer access device as a result of the product consumer having selected a feedback icon on the display.

10. The apparatus of claim 1, wherein the consumer access device further includes an interface for interfacing with a remote server for displaying the feedback form on the display of the consumer access device.

11. The apparatus of claim 1, wherein the feedback engine is configured to update the feedback form automatically upon the receipt of updated product data from the one or more databases of product information.

12. The apparatus of claim 1, wherein the feedback engine is configured to update the feedback form upon execution of a feedback form by the product consumer.

13. The apparatus of claim 1, wherein the feedback form varies based upon the level of expertise of the product consumer regarding the product.

14. The apparatus of claim 13, wherein the feedback form is configured to allow the product consumer to input the level of expertise, the level of expertise being communicated to the feedback engine to allow the feedback engine to vary the feedback form with information from the one or more databases of product information.

15. The apparatus of claim 1, where in the databases of product information are based on Open Linked Data, the Open Linked Data supporting a plurality of standards including OWL, RDF, and SPARQL.

16. Method, comprising:
querying one or more product information databases by a feedback engine to retrieve information about a product for use in a feedback form associated with the product, the feedback form being displayed to a product consumer to allow the product consumer to enter data into the feedback form relating to the product purchased by the product consumer from a provider;
processing the information retrieved from the one or more product information databases regarding the product such that the feedback form is updated by a feedback engine; and
adjusting the level of detail in the feedback form by the feedback engine depending on the knowledge of the product consumer such that the feedback form varies depending on the product consumer.

17. The method of claim 16, wherein the feedback form is displayed on a consumer access device that is configured to provide the product consumer with online access to an online store for purchasing the product and executing the feedback form.

18. The method of claim 16, wherein querying the one or more product information databases occurs at predetermined intervals.

19. The method of claim 16, wherein querying the one or more product information databases occurs upon execution of a feedback form by the product consumer.

20. The method of claim 16, wherein the feedback form is configured to allow the product consumer to input the level of expertise, the level of expertise being communicated to the feedback engine to allow the feedback engine to adjust the feedback form with information from the one or more databases of product information.

21. Non-transitory computer-readable media encoded with data, the encoded data interoperable with a machine to cause:
querying one or more product information databases by a feedback engine to retrieve information about a product for use in a feedback form associated with the product, the feedback form being displayed to a product consumer to allow the product consumer to enter data into the feedback form relating to the product purchased by the product consumer from a provider;
processing the information retrieved from the one or more product information databases regarding the product such that the feedback form is updated by a feedback engine; and
adjusting the level of detail in the feedback form by the feedback engine depending on the knowledge of the product consumer such that the feedback form varies depending on the product consumer.
